(19) United States
(12) Patent Application Publication
(10) Pub. No.: US 2007/0109280 A1
(43) Pub. Date: May 17, 2007

(54) Apparatus and method for reporting tie events in a system that responds to multiple touches

(75) Inventor: Michael R. Sigona, Munich (DE)

Correspondence Address: TYCO ELECTRONICS CORPORATION, MAIL STOP R20/2B, 307 CONSTITUTION DRIVE, MENLO PARK, CA, 94025, US

(73) Assignee: Tyco Electronics Raychem GmbH, Ottobrunn (DE)

(21) Appl. No.: 11/274,561

(22) Filed: Nov. 15, 2005

(51) Int. Cl. G09G 5/00

(52) U.S. Cl. 345/177

(57) ABSTRACT

Method and apparatus for detecting multiple touch events on a touchscreen system and determining the occurrence of tie events. The system comprises a touchscreen, a touchscreen controller and a microprocessor. The touchscreen comprises a touch surface for receiving touch events. Each of the touch events occurs at a discrete location on the touch surface defined by coordinates. The touchscreen controller monitors the touch surface for the touch events. The microprocessor compares the touch events and determines a tie occurrence when the touch events occur within a predetermined time of one another.

### BACKGROUND OF THE INVENTION

This invention relates generally to touch input systems, and more particularly, to methods and apparatus for reporting a tie situation when multiple touches are detected at the same time by the touch input system.

Touch input systems have become ubiquitous throughout industrialized countries. These systems have replaced or supplemented conventional input systems, such as a keyboard or mouse in many applications, including for example, information kiosks, retail point of sale, order input (e.g. restaurants), and industrial line operations. Various sensing technologies are applied in touch input systems currently in the marketplace, including acoustic, resistive, capacitive and infrared. A touch input system is typically used in conjunction with some type of information display system that may include a computer. When a user touches a displayed object, the touch input system communicates the location of the touch to the system.

FIG. 1 illustrates a conventional touch sensor system 100. The touch sensor system 100 generally comprises a touchscreen 105 (also called a touch screen), an example of which may be a touch sensor having a transparent substrate. The system 100 also comprises a lead 111 coupling a controller 110 to the touchscreen 105. A touchscreen system comprising the touchscreen 105 and controller 110 may be used in conjunction with a display device 115. The touch sensor system 100 is configured to respond to a touch on the touchscreen 105 by causing acoustic waves to be transmitted across the touchscreen 105, one or more of which are modulated in the presence of the touch. The controller 110 in turn uses the modulated signal from the waves to identify the location of the touch on the touchscreen 105. The controller 110 also uses the modulated signal to distinguish between valid touches and invalid signals (e.g., signals generated by contamination on the surface of the screen). If the controller 110 identifies a touch as valid, it transmits the touch's location to a host computer (not shown) that then implements a corresponding computer function to display the pertinent information, e.g., graphics, on the display device 115. Graphics or other information may be displayed on the display device 115 in response to an operator's command, e.g. touching a particular area of the touchscreen 105.

FIG. 2 illustrates an acoustic wave touch input system 102. A transparent sensor substrate 120 having a surface 122 covers a screen of a display system. The transparent sensor substrate 120 is typically made of glass. The wave energy is directed along one or more paths that form an invisible XY grid overlaying the substrate surface 122 wherein a touch to the surface 122 causes wave energy to be attenuated.

A first transmitting transducer 125 and a first receiving transducer 135 are provided in two corners of the substrate 120, with the corners being located on a first vertical side of the substrate 120. The first transmitting transducer 125 transmits acoustic waves in the horizontal right direction to be received by the first receiving transducer 135. A second transmitting transducer 130 and a second receiving transducer 140 are oriented perpendicularly to the first transmitting and receiving transducers 125 and 135 on a first horizontal side of the substrate 120. Both the transmitting transducers 125 and 130 and the receiving transducers 135 and 140 may be, for example, piezoelectric transducers. Two reflector arrays 200 and 205 are provided on both horizontal sides of the substrate 120, and two reflector arrays 210 and 215 are provided on both vertical sides of the substrate 120. The reflector arrays partially reflect waves from the transmitting transducers to the receiving transducers.

The controller 110 sends signals to the transmitting transducers 125 and 130 through lines 160 and 165, and the transmitting transducers 125 and 130 generate acoustic energy that is launched across the substrate 120 and reflected by the reflector arrays. The controller 110 accepts signals from the receiving transducers 135 and 140 through lines 190 and 195, and the received signals include timing and signal amplitude. The controller 110 comprises coded instructions (stored, for example, in a memory of a microprocessor), which when executed, perform steps to control and process the relevant signals. The controller 110 need not comprise a computer, but may be implemented in hardware, firmware, software or any combination thereof. The time the wave takes to travel from the transmitting transducers 125 and 130 to the receiving transducers 135 and 140 via the reflector arrays 200, 205, 210 and 215 is dependent on the path length, and therefore the position of an attenuation within the wave can be correlated to the time at which it was received relative to the time it was launched. Waves are periodically and repetitively propagated in both the X and Y directions of the substrate 120 in order to allow the detection of coordinates of a touch event location 250. The time between the repetitive propagation of waves is the sampling time.

As touch input systems incorporate the propagation and detection of acoustic waves, if two or more points are pressed or touched concurrently or within a specific same sampling period of the system, the receiving transducers 135 and 140 will detect multiple X coordinates and multiple Y coordinates within a single time interval in which the coordinates are read. Current systems often discourage a user from using simultaneous touches. When more than one touch is sensed, the system may ignore the touches, and/or ignore any further touchscreen input until the touches are removed, choose one touch over others based on criteria such as location of touch relative to previous touches, or analyze the touch to try to identify if the touch is not intended, such as being caused by a portion of the user's body resting on the touchscreen.

Multiple touches that overlap in time may be detected as simultaneous events. Simultaneous touches occur when the start times for two or more touches are the same within the time resolution of the system (e.g., the time resolution of the microchip controller of the system). Features of the system that can limit time resolution include analog to digital sampling rate, wave propagation velocity, bandwidth of analog circuits, and the like. For example, if the controller 110 samples the touchscreen 105 at a rate of 100 times per second, then touch events arriving within 0.01 second of each another cannot be resolved in time. In some applications, it is likely that two touches will occur somewhere in the screen within 0.01 second. For example, in a video game involving head-to-head competition, this probability may be very high.

In amusement games, it is important that the system treat simultaneous touches equally. Therefore, neither the player on the right nor the player on the left would have an advantage, such as based on location. In gambling applications, the issue of fairness and equality is closely monitored.

Therefore, a need exists for a method and apparatus for identifying a tie situation of touch events occurring within the same time period. Certain embodiments of the present invention are intended to meet these needs and other objectives that will become apparent from the description and drawings set forth below.

### BRIEF SUMMARY OF THE INVENTION

In one embodiment, a touchscreen system for accepting multiple touch events and determining tie events comprises a touchscreen, a touchscreen controller and a microprocessor. The touchscreen comprises a touch surface for receiving touch events. Each of the touch events occurs at a discrete location on the touch surface defined by coordinates. The touchscreen controller monitors the touch surface for the touch events. The microprocessor compares the touch events and determines a tie occurrence when the touch events occur within a predetermined time of one another.

In another embodiment, a method for determining a tie event occurring on a touchscreen system accepting multiple touches comprises monitoring a touchscreen for touch events. Each touch event occurs at a discrete location on the touchscreen defined by a coordinate system. The first and second touch events are compared to determine a relative timing between the first and second touch events, and a tie is determined to have occurred when the relative timing is within a predetermined time.

In another embodiment, a method for reporting a tie event occurring on a touchscreen system accepting multiple inputs comprises monitoring a touchscreen for touch events. Each touch event occurs at a discrete location. A first touch event is detected having a first timing event and a second touch event is detected having a second timing event. A difference between the first and second timing events is compared to a predetermined time, and a flag is set identifying a tie occurrence when the difference is within the predetermined time.

### BRIEF DESCRIPTION OF THE DRAWINGS

FIG. 1 illustrates a conventional touch sensor system.

FIG. 2 illustrates an acoustic wave touch input system.

FIG. 3 illustrates a touch sensor system capable of resolving tie events resulting from multiple touch situations in accordance with an embodiment of the present invention.

FIG. 4 illustrates an acoustic wave touch input system in accordance with an embodiment of the present invention.

FIG. 5 illustrates a method for identifying tie occurrences or tie events resulting from multiple touch situations in accordance with an embodiment of the present invention.

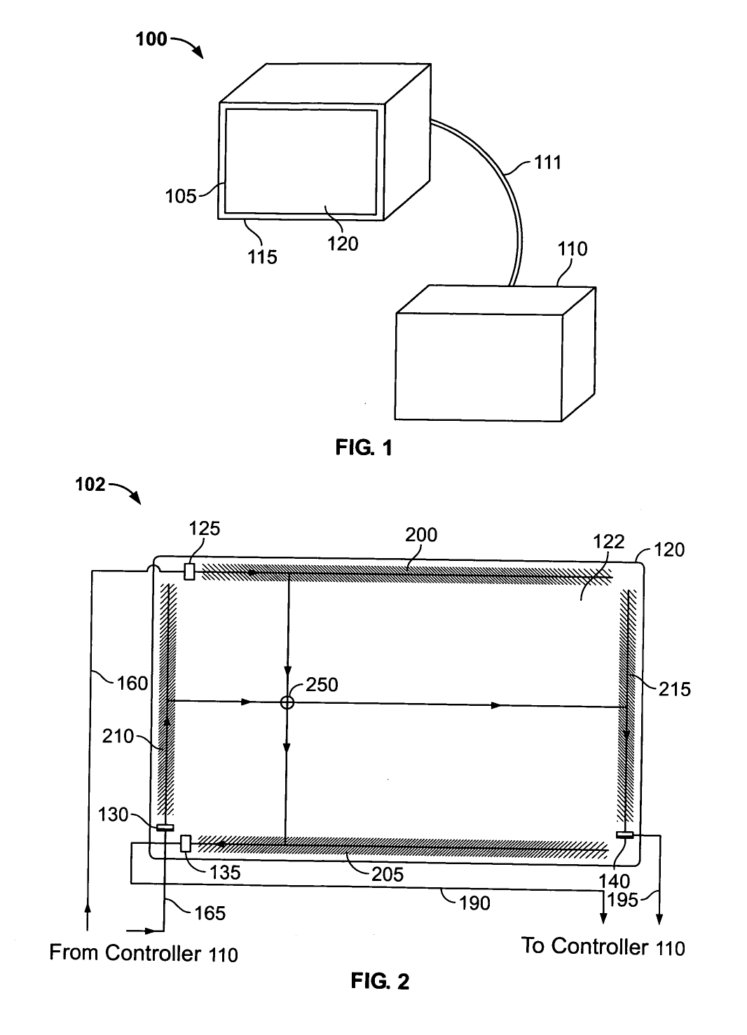

The foregoing summary, as well as the following detailed description of certain embodiments of the present invention, will be better understood when read in conjunction with the appended drawings. The figures illustrate diagrams of the functional blocks of various embodiments. The functional blocks are not necessarily indicative of the division between hardware circuitry. Thus, for example, one or more of the functional blocks (e.g., processors or memories) may be implemented in a single piece of hardware (e.g., a general purpose signal processor or a block or random access memory, hard disk, or the like). Similarly, the programs may be stand alone programs, may be incorporated as subroutines in an operating system, may be functions in an installed imaging software package, and the like. It should be understood that the various embodiments are not limited to the arrangements and instrumentality shown in the drawings.

### DETAILED DESCRIPTION OF THE INVENTION

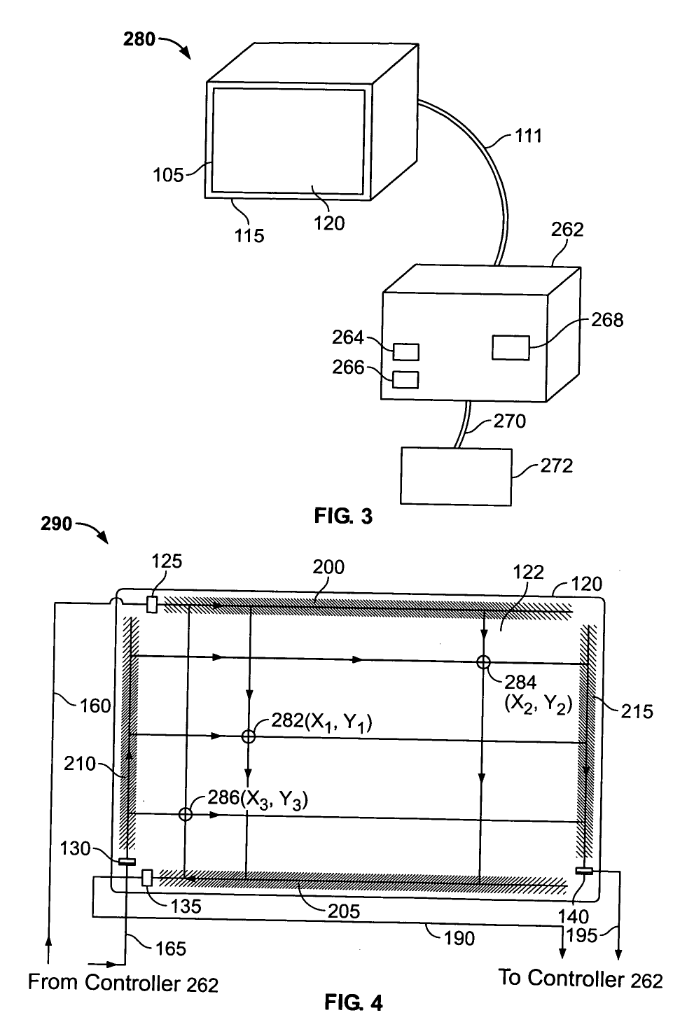

FIG. 3 illustrates a touch sensor system 280 capable of resolving tie events resulting from multiple touch situations in accordance with an embodiment of the present invention. The touch sensor system 280 comprises the display device 115 with the touchscreen 105 and transparent sensor substrate 120 as previously discussed. A controller 262 is interconnected with the touchscreen 105 with the lead 111. Optionally, the controller 262 may also comprise at least one buffer 264 and 266 for temporarily storing coordinate information and/or signals representative of coordinate information.

A microprocessor 268 may receive signals from the touchscreen 105, determine the coordinate information of touch events and determine whether a tie event has occurred, as discussed below. The microprocessor 268 may then output the coordinate information and/or tie event notification to another device such as a central or host computer 272 via lead 270. It should be understood that the coordinate information passed through the lead 270 is representative only. In addition, the information may be output in many forms and formats by the computer 272, such as text or graphics on the display device 115, or on a different display device or monitor, by a light, bell, an initiation or termination of an action, and the like. Therefore, the information passed through the lead 270 may change based on the purpose of the touch sensor system 280. Optionally, the controller 262 may be located within a monitor or the display device 115, in a separate unit as illustrated, or within the computer 272.

FIG. 4 illustrates an acoustic wave touch input system 290 in accordance with an embodiment of the present invention. Elements in common with FIG. 2 are labeled with like item numbers. Although surface acoustic waves (SAW) are illustrated, it should be understood that other sensing technologies may also be used, including, but not limited to, acoustic, resistive, capacitive and infrared.

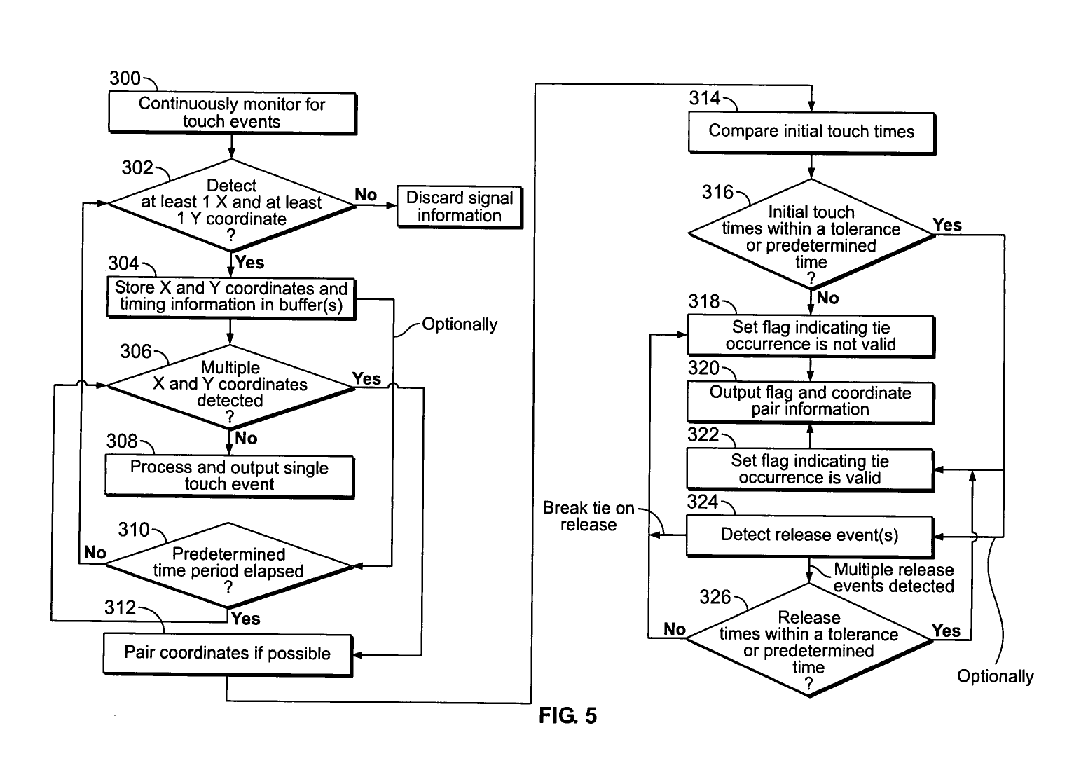

FIG. 5 illustrates a method for identifying tie occurrences or tie events resulting from multiple touch situations in accordance with an embodiment of the present invention. FIGS. 3 to 5 will be discussed together.

In step 300, the controller 262 begins the scan process to continuously monitor the touchscreen 105 for touch events. For example, the controller 262 may send a signal to the first transmitting transducer 125 via line 160. The first receiving transducer 135 sends a first returning signal via line 190 to the controller 262. The controller 262 then sends a signal to the second transmitting transducer 130 via line 165. The second receiving transducer 140 sends a second returning signal via line 195 to the controller 262. As stated previously, the returning signal includes timing and signal amplitude information representative of touch events, if present. Therefore, the controller 262 constantly sends and receives signals in both the X and Y directions in order to detect the coordinates of one or more touch events. The time between the repetitive propagation of waves is the sampling rate or time, and a measurement period may be defined as the time period for the microprocessor 268 to send and receive the first and second sets of signals.

In step 302, the microprocessor 268 analyzes the first and second returning signals to determine whether one or more X and Y coordinates are detected. If no X or Y coordinates are detected, the first and second returning signal information may be discarded. If at least one X and at least one Y coordinate are detected, flow passes to step 304. It should be understood that steps 300 and 302 are repeatedly performed so that the touchscreen 105 is continuously monitored for touch events.

In step 304, the microprocessor 268 stores the detected X and Y coordinates in one or more buffers 264 and 266. For example, a first coordinate series of X coordinates may be stored in a memory or buffer 264 and a second coordinate series of Y coordinates may be stored in a memory or buffer 266. Alternatively, a single buffer 264 may be used to store all detected coordinates. Optionally, sets of signals representative of the coordinates may be stored, wherein the microprocessor 268 or other device may identify the actual X and Y coordinate locations later.

The timing information for each coordinate is also stored in the buffers 264 and 266. The timing information may be a time based on a reference clock or the sampling period, and indicates an initial touch time or timing event. The initial touch time represents the first time the touch event is detected on the touchscreen 105.

Flow then passes to either step 306 or step 310. In step 306, the microprocessor 268 determines whether multiple X and Y coordinates were detected, indicating a multiple touch situation. If multiple touches were not detected, flow passes to step 308 where the microprocessor 268 may process the returning signals according to known methods. For example, if a single X and Y coordinate have been detected and stored in the buffers 264 and 266, the microprocessor 268 may identify the touch location and output the touch coordinates and/or sets of signals (step 308) to a central or host computer 272. It should be understood that the microprocessor 268 may not store the detected X and Y coordinates in the buffers 264 and 266 (step 304) if a single touch is detected in step 302.

Returning to step 304, the microprocessor 268 may optionally be set to scan for touch events for a predetermined period of time. In step 310, the microprocessor 268 determines if the predetermined period of time has elapsed. The predetermined time may, for example, be based on a sampling rate or time in which the touchscreen 105 is monitored for touch events (step 300). Alternatively, the predetermined period of time may be set by an application, such as a gaming application, and define a duration of time during which detected touch events are considered to be tie events. Optionally, the microprocessor 268 may oversample by scanning multiple times within the predetermined time period and then average the samples, resulting in a single sample within the predetermined time period. If time remains in the predetermined period of time, flow returns to step 302, and if the microprocessor 268 detects one or more additional touches on the touchscreen 105 within the predetermined period of time, the additional touch data is stored in the buffers 264 and 266 (step 304). If the predetermined period of time has elapsed, flow passes to step 306.

If multiple touches are detected in step 306, flow passes to step 312 where the microprocessor 268 pairs the X and Y coordinates, if possible. For example, if touch events occurred at touch locations 282 and 284 such that, in step 302, the microprocessor 268 detected coordinate series X₁, X₂ and Y₁, Y₂ within a predetermined time or measurement period of one another, the microprocessor 268 may or may not be able to determine the pairing of the X and Y coordinates and may utilize other methods to determine the pairing. It should be understood that more than two touch events may be detected at the same time, resulting in additional X and Y coordinates to be paired. For example, touch location 286 (X₃, Y₃) may be detected at the same time as touch locations 282 and 284. Optionally, the microprocessor 268 may identify the coordinates as unchanged when within a tolerance, such as to account for a slight finger movement or roll of the user's finger along the touch surface.

In step 314, the microprocessor 268 compares the initial touch times of the touch events stored in the buffers 264 and 266 to determine the relative timing. As stated previously, the initial touch time may be defined by the sampling period in which the touch event was detected.

In step 316, the microprocessor 268 determines whether the initial touch times of the touch events are within a tolerance or predetermined time of one another. A first application may declare a tie event when two or more initial touch times occur during the same sampling period. A second application may define a larger window of time within which multiple touches are considered to be simultaneous, such as 0.25 seconds or a set number of sampling periods, such as 2 sampling periods.

If the initial touch times are not within the preset tolerance or predetermined time, flow passes to step 318. The microprocessor 268 sets a flag within a packet of information indicating that a tie has not occurred. The packet of information also may comprise the XY coordinate pairs, if known, and indicate which coordinate pair occurred first in time. For example, in a gaming situation, the touch event that was first is the winner. In step 320, the microprocessor 268 outputs or transmits the packet of information to the central or host computer 272 for implementation of the desired function and clears the buffers 264 and 266.

Returning to step 316, if the initial touch times are within the preset tolerance or predetermined time, a tie event has occurred and flow passes to either step 322 or step 324, depending upon the application. In step 322, the microprocessor 268 sets a flag within a packet of information indicating that a tie occurrence has been detected and is valid. The packet of information also comprises the XY coordinate pairs, if known. Then, in step 320, the microprocessor 268 outputs or transmits the packet of information comprising the flag and the XY coordinate pair information to the central or host computer 272 for implementation of the desired function, and clears the buffers 264 and 266. Therefore, a tie may be declared and both players awarded a prize or points, or a tie-breaking scenario may be initiated.

In step 324, an application may be designed to eliminate a tie situation by identifying a release or timing event which is correlated to one of the touch events. A release event occurs when a user lifts a finger or stylus from the touchscreen 105. The microprocessor 268 continues to scan for touch events until one or more release events are detected. That is, the microprocessor 268 detects one less X and one less Y coordinate present in subsequently returned signals. The microprocessor 268 correlates the release event with one of the touch events, such as by comparing the subsequently returned signals to the coordinates or signals stored in the buffers 264 and 266. The missing X and Y coordinates indicate the touch location correlated with the release event. Also, the coordinates can now be paired, if desired. The microprocessor 268 also knows the release time of the release event.

In some applications, a tie may be broken when a first release event is detected. Therefore, if two players created first and second touch events at the same time, or substantially the same time as determined in step 316, the first player to release their finger from the touchscreen 105 would be the winner. Flow then passes from step 324 to 318, indicating the winner and that no tie has occurred.

Other applications may award a tie when multiple release events are detected within a tolerance or predetermined time of one another. After a first release event is detected (step 324), the microprocessor 268 continues to scan the touchscreen 105 to detect touch and/or release events (step 300). Depending upon the application, newly detected touch events may be ignored. When a second and/or subsequent release event is detected and correlated with one of the touch events, flow passes to step 326. Alternatively, after the first release event is detected, the microprocessor 268 may continue to scan the touchscreen 105 for release events for a predetermined time before flow passes to step 326, or the microprocessor 268 may continue to scan until all remaining release events have been detected.

In step 326, the microprocessor 268 compares the release times for the touch events to determine whether the release times are within a tolerance or predetermined time of each other. If two or more of the release events are within the tolerance or predetermined time of each other, a tie has occurred and flow passes to step 322. In step 322, the microprocessor 268 sets the flag indicating that a tie occurrence is valid, and outputs or transmits the packet of information comprising the flag and the XY coordinate pair information (step 320) to the central or host computer 272 for implementation of the desired function, and clears the buffers 264 and 266.

If the release times in step 326 are not within the tolerance, the user who removed a finger from the touchscreen 105 first, achieving the earlier release time, is the winner. The tie occurrence is not valid and flow passes to step 318.

Therefore, rather than discarding the touch events or declaring a winner, such as through the nature of the algorithm, a touchscreen system can determine and report tie occurrences or tie events. By improving the ability to establish a tie situation, players in a game may experience a greater level of satisfaction based on the equal treatment of player inputs.

While the invention has been described in terms of various specific embodiments, those skilled in the art will recognize that the invention can be practiced with modification within the spirit and scope of the claims.

What is claimed is:

1. A touchscreen system for accepting multiple touch events and determining tie events, comprising:
a touchscreen comprising a touch surface for receiving touch events, each of the touch events occurring at a discrete location on the touch surface defined by coordinates;
a touchscreen controller for monitoring the touch surface for the touch events; and
a microprocessor for comparing the touch events, the microprocessor determining a tie occurrence when the touch events occur within a predetermined time of one another.

2. The touchscreen system of claim 1, the microprocessor identifying first and second initial touch times corresponding to first and second touch events, the microprocessor determining the tie occurrence when a difference between first and second initial touch times is within the predetermined time.

3. The touchscreen system of claim 1, the microprocessor identifying first and second release times corresponding to first and second touch events, the microprocessor determining the tie occurrence when a difference between first and second release times is within the predetermined time.

4. The touchscreen system of claim 1, the touchscreen controller identifying XY coordinates for each of the touch events, the touchscreen controller further comprising an output for outputting a packet of touch event data comprising XY coordinates representative of the touch events and a flag indicating whether the tie occurrence is valid for the touch events.

5. The touchscreen system of claim 1, the microprocessor comparing first and second initial touch times corresponding to first and second touch events, the microprocessor determining an earlier touch event when a difference between the first and second initial touch times is greater than the predetermined time.

6. The touchscreen system of claim 1, the microprocessor comparing first and second initial release times corresponding to first and second touch events, the microprocessor determining an earlier release event when a difference between the first and second initial release times is greater than the predetermined time.

7. The touchscreen system of claim 1, further comprising at least one buffer for storing the touch events after the touch events are detected by the touchscreen controller.

8. The touchscreen system of claim 1, wherein the touchscreen controller reading touch data from the touchscreen at a sampling rate, the predetermined time being based on the sampling rate.

9. A method for determining a tie event occurring on a touchscreen system accepting multiple touches, comprising:
monitoring a touchscreen for touch events, each touch event occurring at a discrete location on the touchscreen defined by a coordinate system;
comparing first and second touch events to determine a relative timing between the first and second touch events; and
determining that a tie event has occurred when the relative timing is within a predetermined time.

10. The method of claim 9, wherein the first and second touch events occur substantially simultaneously.

11. The method of claim 9, wherein the predetermined time is based on a sampling rate at which the touchscreen is monitored for the touch events.

12. The method of claim 9, wherein the first and second touch events are detected within a single sampling period.

13. The method of claim 9, further comprising:
detecting first and second initial touch times corresponding to the first and second touch events, the relative timing of the first and second initial touch times of the first and second touch events being within the predetermined time;
monitoring the touchscreen for a first release event associated with one of the first and second touch events; and
determining that the tie event has not occurred based on the first release event.

14. The method of claim 9, further comprising:
detecting first and second initial touch times corresponding to the first and second touch events within one sampling period;
monitoring the touchscreen for first and second release events associated with the first and second touch events;
comparing the first and second release events to determine the relative timing; and
determining that the tie event has occurred when the first and second release events are detected substantially simultaneously.

15. The method of claim 9, the predetermined time being one of N sampling periods, wherein one sampling period represents a time period needed to read the coordinate system of the touchscreen, N being a number equal to or greater than 1.

16. A method for reporting a tie event occurring on a touchscreen system accepting multiple inputs, comprising:
monitoring a touchscreen for touch events, each touch event occurring at a discrete location;
detecting a first touch event having a first timing event;
detecting a second touch event having a second timing event;
comparing a difference between the first and second timing events to a predetermined time; and
setting a flag identifying a tie occurrence when the difference is within the predetermined time.

17. The method of claim 16, wherein the first and second timing events being initial touch times associated with the first and second touch events.

18. The method of claim 16, wherein the first and second timing events being release times associated with the first and second touch events.

19. The method of claim 16, further comprising:
setting the predetermined time with an application, and sending a packet of information comprising the flag and touch data representative of the first and second touch events to the application for processing.

20. The method of claim 16, further comprising:
after detecting the first touch event, storing the first timing event and positional information representative of the first touch event in a buffer; and
after detecting the second touch event, storing the second timing event and positional information representative of the second touch event in the buffer.
